(19) United States
(12) Patent Application Publication
(10) Pub. No.: US 2021/0402475 A1
(43) Pub. Date: Dec. 30, 2021

(54) ALLOY POWDER FOR ADDITIVE MANUFACTURING, ADDITIVELY MANUFACTURED MATERIAL, AND ADDITIVE MANUFACTURING METHOD

(71) Applicant: MITSUBISHI HEAVY INDUSTRIES, LTD., Tokyo (JP)

(72) Inventors: Masaki TANEIKE, Tokyo (JP); Daichi AKAMA, Tokyo (JP); Shuji TANIGAWA, Tokyo (JP); Masashi KITAMURA, Tokyo (JP)

(73) Assignee: MITSUBISHI HEAVY INDUSTRIES, LTD., Tokyo (JP)

(21) Appl. No.: 17/470,601

(22) Filed: Sep. 9, 2021

Related U.S. Application Data
(63) Continuation of application No. PCT/JP2019/039493, filed on Oct. 7, 2019.

(30) Foreign Application Priority Data
Mar. 22, 2019 (JP) 2019-054229

(51) Int. Cl. B22F 10/28; B33Y 70/00; B33Y 10/00; C22C 19/05

(52) U.S. Cl. CPC B22F 10/28; B33Y 70/00; B22F 2301/15; C22C 19/058; B33Y 10/00

(57) ABSTRACT

An alloy powder for additive manufacturing according to an embodiment is composed of a nickel-based alloy and comprises: 0.0 mass % or more and less than 4.0 mass % of cobalt; 12 mass % or more and 25 mass % or less of chromium; 1.0 mass % or more and 5.5 mass % or less of aluminum; 0.0 mass % or more and 4.0 mass % or less of titanium; 0.0 mass % or more and 3.0 mass % or less of tantalum; and less than 1.5 mass % of niobium.

### CROSS-REFERENCE TO RELATED APPLICATIONS

This application is a continuation of PCT International Application No. PCT/JP2019/039493, which claims priority to Japanese Patent Application No. 2019-054229, filed in Japan on Mar. 22, 2019, the contents of which are hereby incorporated by reference in its entirety.

### TECHNICAL FIELD

The present disclosure relates to an alloy powder for additive manufacturing, an additively manufactured material, and an additive manufacturing method.

### BACKGROUND

In recent years, an additive manufacturing method which obtains a three-dimensional object by additive manufacturing of metal has been used as a method for manufacturing various metal products. For example, in the powder bed additive manufacturing method, a three-dimensional object is formed by irradiating metal powder spread in a layer with an energy beam such as a laser beam or an electron beam to melt and solidify the metal powder repeatedly layer by layer.

In an area irradiated with an energy beam, the metal powder is rapidly melted and then rapidly cooled and solidified to form a solidified metal layer. By repeating this process, a three-dimensional additively manufactured material is formed.

On the other hand, it is known that Ni-based alloy containing Ni as a main component has high heat resistance and high high-temperature strength. Materials composed of Ni-based alloy produced by casting have been widely used for heat-resistant materials that require high-temperature strength, such as turbine parts for gas turbines.

Further, in recent years, for manufacturing a part composed of Ni-based alloy having a complicated shape such as a turbine blade, an attempt has been made to apply an additive manufacturing method which enables direct shaping without a complicated manufacturing process (for example, Patent Document 1).

### CITATION LIST

### Patent Literature

Patent Document 1: JP2018-168400A

### SUMMARY

### Problems to be Solved

In an additively manufactured material of Ni-based alloy produced by the additive manufacturing method, crystal grains are fine and extended in the building orientation due to rapid solidification after energy beam irradiation. Accordingly, in the additively manufactured material, physical properties such as strength differ depending on the orientation due to the anisotropy of crystals. Therefore, in order to reduce the anisotropy of crystals, it is conceivable to heat-treat the additively manufactured material to coarsen the crystal grains to bring them closer to an isotropic form.

In a conventional product of Ni-based alloy produced by casting, MC carbides, which hinder the movement of grain boundaries, are dispersed at the grain boundaries in a relatively large form. However, in the additively manufactured material of Ni-based alloy produced by the additive manufacturing method, due to rapid solidification after energy beam irradiation, fine MC carbides are dispersed and precipitated at the grain boundaries or in the crystal grains. Accordingly, the dispersed fine MC carbides hinder the movement of grain boundaries caused by heat treatment, making it difficult to coarsen the crystal grains and bring them closer to an isotropic form.

Even in the case of the additively manufactured material composed of Ni-based alloy produced by the additive manufacturing method, it is possible to coarsen the crystal grains and bring them closer to an isotropic form by performing heat treatment at a high temperature close to the melting point. However, a part having a complicated shape may deform due to the heat treatment at a high temperature close to the melting point. Thus, it is desirable to perform heat treatment at a lower temperature.

In view of the above, an object of at least one embodiment of the present invention is to reduce the anisotropy of crystals of an additively manufactured material composed of Ni-based alloy.

### Solution to the Problems

(1) An alloy powder for additive manufacturing according to at least one embodiment of the present invention is composed of a nickel-based alloy and comprises:

0.0 mass % or more and less than 4.0 mass % of cobalt;

12 mass % or more and 25 mass % or less of chromium;

1.0 mass % or more and 5.5 mass % or less of aluminum;

0.0 mass % or more and 4.0 mass % or less of titanium;

0.0 mass % or more and 3.0 mass % or less of tantalum; and

less than 1.5 mass % of niobium.

As a result of studies by the present inventors, it was found that in order to suppress the precipitation of MC carbides in an additively manufactured material made of nickel-based alloy obtained by additive manufacturing, it is preferable to reduce the contents of titanium, tantalum, and niobium and reduce the content of cobalt in an additive manufacturing alloy powder. Further, as a result of studies by the present inventors, it was found that in order to secure the elements constituting the γ′ phase for improving the strength of the additively manufactured material, it is preferable to increase the contents of aluminum and tantalum in the additive manufacturing alloy powder.

Based on these points, as a result of studies, the present inventors found that when the composition of elements in the additive manufacturing alloy powder composed of nickel-based alloy is as described in the above (1), the precipitation of MC carbides in the additively manufactured material can be effectively suppressed.

Thus, in the additively manufactured material obtained by additive manufacturing using the additive manufacturing alloy powder having the configuration (1), the precipitation of MC carbides can be effectively suppressed. As a result, the movement of grain boundaries by heat treatment is less likely to be inhibited by MC carbides in the additively manufactured material, which makes it easier to coarsen the crystal grains and bring them closer to an isotropic form. Therefore, it is possible to lower the heat treatment temperature of the additively manufactured material, and it is possible to suppress the deformation of the additively manufactured material due to heat treatment.

(2) In some embodiments, in the above configuration (1), the alloy powder comprises 0.0 mass % or more and less than 1.0 mass % of cobalt.

As a result of studies by the present inventors, it was found that in order to suppress the precipitation of MC carbides in the additively manufactured material made of nickel-based alloy obtained by additive manufacturing, it is more preferable to set the content of cobalt in the additive manufacturing alloy powder to less than 1.0 mass %.

In this regard, with the above configuration (2), since the content of cobalt is 0.0 mass % or more and less than 1.0 mass %, it is possible to more effectively suppress the precipitation of MC carbides in the additively manufactured material.

(3) In some embodiments, in the above configuration (1) or (2), the alloy powder comprises 0.0 mass % or more and 2.0 mass % or less of titanium.

As a result of studies by the present inventors, it was found that in order to suppress the precipitation of MC carbides in the additively manufactured material made of nickel-based alloy obtained by additive manufacturing, it is more preferable to set the content of titanium in the additive manufacturing alloy powder to 0.0 mass % or more and 2.0 mass % or less.

In this regard, with the above configuration (3), since the content of titanium is 0.0 mass % or more and 2.0 mass % or less, it is possible to more effectively suppress the precipitation of MC carbides in the additively manufactured material.

(4) In some embodiments, in any one of the above configurations (1) to (3), the alloy powder comprises 0.0 mass % or more and less than 1.0 mass % of niobium.

As a result of studies by the present inventors, it was found that in order to suppress the precipitation of MC carbides in the additively manufactured material made of nickel-based alloy obtained by additive manufacturing, it is more preferable to set the content of niobium in the additive manufacturing alloy powder to less than 1.0 mass %.

In this regard, with the above configuration (4), since the content of niobium is 0.0 mass % or more and less than 1.0 mass %, it is possible to more effectively suppress the precipitation of MC carbides in the additively manufactured material.

(5) In some embodiments, in any one of the above configurations (1) to (4), a rhenium content is at or below a detection limit.

As a result of studies by the present inventors, it was found that in order to suppress the precipitation of MC carbides in the additively manufactured material made of nickel-based alloy obtained by additive manufacturing, rhenium does not need to be added in the additive manufacturing alloy powder.

Therefore, with the above configuration (5), since rhenium, which is a kind of expensive rare metal, does not need to be added, it is possible to reduce the cost of the additive manufacturing alloy powder.

(6) In some embodiments, in any one of the above configurations (1) to (5), a ruthenium content is at or below a detection limit.

As a result of studies by the present inventors, it was found that in order to suppress the precipitation of MC carbides in the additively manufactured material made of nickel-based alloy obtained by additive manufacturing, ruthenium does not need to be added in the additive manufacturing alloy powder.

Therefore, with the above configuration (6), since ruthenium, which is a kind of expensive rare metal, does not need to be added, it is possible to reduce the cost of the additive manufacturing alloy powder.

(7) In some embodiments, in any one of the above configurations (1) to (6), when a first parameter P1 is represented by the following expression (A):

P1=0.08×Ti+0.15×Ta+0.19×Nb (A), and

a second parameter P2 is represented by the following expression (B):

P2=0.04×Co−0.03×Cr (B),

where Ti (mass %) is a parameter related to a titanium content,

Ta (mass %) is a parameter related to a tantalum content,

Nb (mass %) is a parameter related to a niobium content,

Co (mass %) is a parameter related to a cobalt content, and

Cr (mass %) is a parameter related to a chromium content,

the first parameter P1 and the second parameter P2 satisfy a relation represented by the following expression (C):

P1<−1.24×P2−0.27 (C).

The effects of each element on the precipitation of MC carbides were examined by the inventors by classifying the elements into those that directly constitute MC carbides and those that are present in solid solution with the matrix and affect the precipitation of MC carbides, and the following was found: When the first parameter P1 for titanium, tantalum, and niobium, which are constituent elements of MC carbides, and the second parameter P2 for cobalt and chromium, which are elements that are dissolved in the matrix and have an effect on the precipitation of MC carbides, satisfy the relation represented by the expression (C), the precipitation of MC carbides can be effectively suppressed.

Therefore, with the above configuration (7), it is possible to effectively suppress the precipitation of MC carbides in the additively manufactured material.

(8) An additive manufacturing method according to at least one embodiment of the present invention comprises: a first heat treatment step to remove a stress of an additively manufactured material formed by additive manufacturing using the additive manufacturing alloy powder having any one of the above configurations (1) to (7); and a second heat treatment step of performing heat treatment at a temperature lower than 1250° C. to coarsen a crystal grain of the additively manufactured material after the first heat treatment step.

With the above method (8), by using the additive manufacturing alloy powder having any one of the above configurations (1) to (7), it is possible to coarsen the crystal grains and bring them closer to an isotropic form even when the heat treatment temperature of the additively manufactured material is lower than 1250° C.

Therefore, with the above method (8), it is possible to reduce the anisotropy of crystals while suppressing the deformation of the additively manufactured material composed of Ni-based alloy.

(9) In some embodiments, in the above method (8), the second heat treatment step includes performing heat treatment of the additively manufactured material at a temperature equal to or lower than 1230° C.

With the above method (9), it is possible to reduce the anisotropy of crystals while more effectively suppressing the deformation of the additively manufactured material composed of Ni-based alloy.

(10) An additively manufactured material according to at least one embodiment of the present invention is composed of a nickel-based alloy and comprises:

0.0 mass % or more and less than 4.0 mass % of cobalt;

12 mass % or more and 25 mass % or less of chromium;

1.0 mass % or more and 5.5 mass % or less of aluminum;

0.0 mass % or more and 4.0 mass % or less of titanium;

0.0 mass % or more and 3.0 mass % or less of tantalum; and

less than 1.5 mass % of niobium.

As a result of studies by the present inventors, it was found that when the composition of elements in the additively manufactured material composed of nickel-based alloy is as described in the above (10), the precipitation of MC carbides can be effectively suppressed.

With the above configuration (10), grain boundary migration by heat treatment is less likely to be inhibited by MC carbides, which makes it easier to coarsen the crystal grains and bring them closer to an isotropic form. Therefore, it is possible to lower the heat treatment temperature of the additively manufactured material, and it is possible to suppress the deformation of the additively manufactured material due to heat treatment.

(11) In some embodiments, in the above configuration (10), the additively manufactured material comprises 0.0 mass % or more and less than 1.0 mass % of cobalt.

As a result of studies by the present inventors, it was found that when the content of cobalt in the additively manufactured material composed of nickel-based alloy is 0.0 mass % or more and less than 1.0 mass %, the precipitation of MC carbides can be more effectively suppressed.

In this regard, with the above configuration (11), it is possible to more effectively suppress the precipitation of MC carbides.

(12) In some embodiments, in the above configuration (10) or (11), the additively manufactured material comprises 0.0 mass % or more and 2.0 mass % or less of titanium.

As a result of studies by the present inventors, it was found that when the content of titanium in the additively manufactured material composed of nickel-based alloy is 0.0 mass % or more and 2.0 mass % or less, the precipitation of MC carbides can be more effectively suppressed.

In this regard, with the above configuration (12), it is possible to more effectively suppress the precipitation of MC carbides.

(13) In some embodiments, in any one of the above configurations (10) to (12), the additively manufactured material comprises 0.0 mass % or more and less than 1.0 mass % of niobium.

As a result of studies by the present inventors, it was found that when the content of niobium in the additively manufactured material composed of nickel-based alloy is 0.0 mass % or more and less than 1.0 mass %, the precipitation of MC carbides can be more effectively suppressed.

In this regard, with the above configuration (13), it is possible to more effectively suppress the precipitation of MC carbides.

(14) In some embodiments, in any one of the above configurations (10) to (13), a rhenium content is at or below a detection limit.

As a result of studies by the present inventors, it was found that in order to suppress the precipitation of MC carbides, rhenium does not need to be added in the additively manufactured material composed of nickel-based alloy.

Therefore, with the above configuration (14), since rhenium, which is a kind of expensive rare metal, does not need to be added, it is possible to reduce the cost of the additively manufactured material.

(15) In some embodiments, in any one of the above configurations (10) to (14), a ruthenium content is at or below a detection limit.

As a result of studies by the present inventors, it was found that in order to suppress the precipitation of MC carbides, ruthenium does not need to be added in the additively manufactured material composed of nickel-based alloy.

Therefore, with the above configuration (15), since ruthenium, which is a kind of expensive rare metal, does not need to be added, it is possible to reduce the cost of the additively manufactured material.

(16) In some embodiments, in any one of the above configurations (10) to (15), when a first parameter P1 is represented by the following expression (A):

P1=0.08×Ti+0.15×Ta+0.19×Nb (A), and

a second parameter P2 is represented by the following expression (B):

P2=0.04×Co−0.03×Cr (B),

where Ti (mass %) is a parameter related to a titanium content,

Ta (mass %) is a parameter related to a tantalum content,

Nb (mass %) is a parameter related to a niobium content,

Co (mass %) is a parameter related to a cobalt content, and

Cr (mass %) is a parameter related to a chromium content,

the first parameter P1 and the second parameter P2 satisfy a relation represented by the following expression (C):

P1<−1.24×P2−0.27 (C).

As described above, when the first parameter P1 and the second parameter P2 satisfy the relation represented by the expression (C), the precipitation of MC carbides can be effectively suppressed.

Therefore, with the above configuration (16), it is possible to effectively suppress the precipitation of MC carbides.

(17) In some embodiments, in any one of the above configurations (10) to (16), an aspect ratio of a crystal grain of the additively manufactured material is 1 or more and less than 3.

In the additively manufactured material having any one of the configurations (10) to (16), since the precipitation of MC carbides is effectively suppressed, the movement of grain boundaries by heat treatment is less likely to be inhibited by MC carbides. This makes it easier to coarsen the crystal grains such that the aspect ratio of the crystal grain is 1 or more and less than 3.

With the above configuration (17), since the aspect ratio of the crystal grain is 1 or more and less than 3, it is possible to reduce the variation in physical properties including strength of the additively manufactured material depending on the orientation.

### Advantageous Effects

According to at least one embodiment of the present invention, it is possible to reduce the anisotropy of crystals of an additively manufactured material composed of Ni-based alloy.

### BRIEF DESCRIPTION OF DRAWINGS

FIG. 1 is a schematic diagram of the microstructure of a conventional casting made of nickel-based alloy manufactured by casting and the microstructure of an additively manufactured material made of nickel-based alloy manufactured by the additive manufacturing method.

FIG. 2 is a schematic diagram of the microstructure of an additively manufactured material made of a conventional additive manufacturing alloy powder and an additively manufactured material made of an additive manufacturing alloy powder according to some embodiments.

FIG. 3 is a table showing the composition of the additive manufacturing alloy powder according to some embodiments.

FIG. 4 is a schematic diagram of an example of the microstructure of the additively manufactured material obtained by additive manufacturing using the additive manufacturing alloy powder according to some embodiments before and after heat treatment.

FIG. 5 is a diagram of the microstructure of the additively manufactured material made of the conventional additive manufacturing alloy powder after heat treatment.

FIG. 6 is a diagram of the microstructure of the additively manufactured material made of the additive manufacturing alloy powder according to some embodiments after heat treatment.

FIG. 7 is a graph showing a relationship between the first parameter and the second parameter for each element contained in the additive manufacturing alloy powder according to some embodiments.

FIG. 8 is a table showing the composition and component in each plot in FIG. 7.

FIG. 9 is a flowchart of heat treatment of the additively manufactured material obtained by additive manufacturing using the additive manufacturing alloy powder according to some embodiments.

### DETAILED DESCRIPTION

Embodiments of the present invention will now be described in detail with reference to the accompanying drawings. It is intended, however, that unless particularly identified, dimensions, materials, shapes, relative positions, and the like of components described in the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

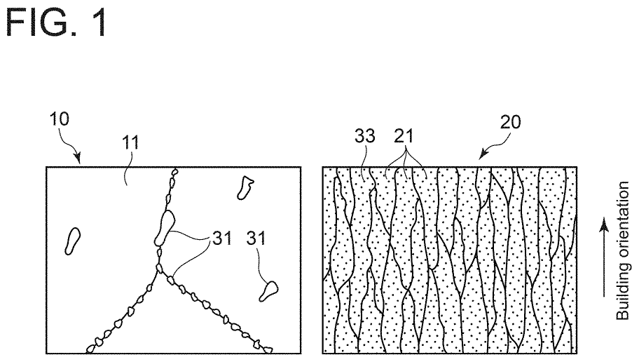

FIG. 1 is a schematic diagram of the microstructure of a conventional casting made of nickel-based alloy manufactured by casting and the microstructure of an additively manufactured material made of nickel-based alloy manufactured by the additive manufacturing method.

In an additively manufactured material 20 of nickel-based alloy produced by the additive manufacturing method, crystal grains 21 are fine and extended in the building orientation due to rapid solidification after energy beam irradiation. Accordingly, in the additively manufactured material 20, physical properties such as strength differ depending on the orientation due to the anisotropy of crystals. Therefore, in order to reduce the anisotropy of crystals, it is conceivable to heat-treat the additively manufactured material 20 to coarsen the crystal grains to bring them closer to an isotropic form.

Meanwhile, in a conventional casting 10 of nickel-based alloy produced by casting, crystal grains 11 have relatively large grain size, and MC carbides 31, which hinder the movement of grain boundaries, are dispersed at the grain boundaries in a relatively large form. However, in the additively manufactured material 20 of nickel-based alloy produced by the additive manufacturing method, due to rapid solidification after energy beam irradiation, fine MC carbides 33 are dispersed and precipitated at the grain boundaries or in the crystal grains. Accordingly, the dispersed fine MC carbides 33 hinder the movement of grain boundaries caused by heat treatment, making it difficult to coarsen the crystal grains and bring them closer to an isotropic form. In other words, even if the additively manufactured material 20 composed of nickel-based alloy is subjected to heat treatment at a temperature of lower than 1250° C., there is no significant change in the shape of the crystal grains.

Even in the case of the additively manufactured material 20 composed of nickel-based alloy produced by the additive manufacturing method, it is possible to coarsen the crystal grains and bring them closer to an isotropic form by performing heat treatment at a high temperature close to the melting point. However, in the case where the additively manufactured material 20 is a part having a complicated shape, the additively manufactured material 20 may deform due to the heat treatment at a high temperature close to the melting point. Thus, it is desirable to perform heat treatment at a lower temperature.

As a result of studies by the present inventors, it was found that in order to suppress the precipitation of MC carbides in the additively manufactured material 20 made of nickel-based alloy obtained by additive manufacturing, it is preferable to reduce the contents of titanium, tantalum, and niobium and reduce the content of cobalt in an additive manufacturing alloy powder. Further, as a result of studies by the present inventors, it was found that in order to secure the elements constituting the γ′ phase for improving the strength of the additively manufactured material 20, it is preferable to increase the contents of aluminum and tantalum in the additive manufacturing alloy powder.

Based on these points, as a result of studies, the present inventors found that when the composition of elements in the additive manufacturing alloy powder composed of nickel-based alloy is as below, the precipitation of MC carbides in the additively manufactured material 20 can be effectively suppressed.

Specifically, the additive manufacturing alloy powder composed of nickel-based alloy may comprise: less than 4.0 mass % of cobalt; 1.0 mass % or more and 5.5 mass % or less of aluminum; 0.0 mass % or more and 4.0 mass % or less of titanium; 0.0 mass % or more and 3.0 mass % or less of tantalum; and less than 1.5 mass % of niobium.

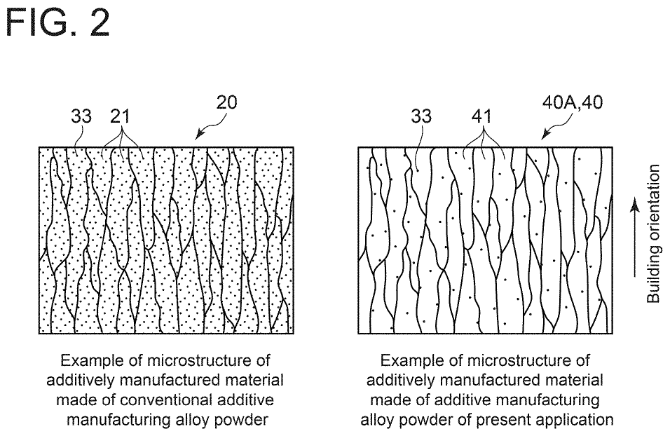

FIG. 2 is a schematic diagram of the microstructure of an additively manufactured material 20 made of a conventional additive manufacturing alloy powder and an additively manufactured material 40 made of an additive manufacturing alloy powder according to some embodiments. As shown in FIG. 2, in the additively manufactured material 40 made of the additive manufacturing alloy powder according to some embodiments, the precipitation amount of MC carbides can be reduced compared to the additively manufactured material 20 made of the conventional additive manufacturing alloy powder.

Thus, in the additively manufactured material 40 obtained by additive manufacturing using the additive manufacturing alloy powder having the above-described composition, the precipitation of MC carbides 33 can be effectively suppressed. As a result, in the additively manufactured material 40, the movement of grain boundaries by heat treatment is less likely to be inhibited by MC carbides, which makes it easier to coarsen the crystal grains and bring them closer to an isotropic form. Therefore, it is possible to lower the heat treatment temperature of the additively manufactured material 40, and it is possible to suppress the deformation of the additively manufactured material 40 due to heat treatment.

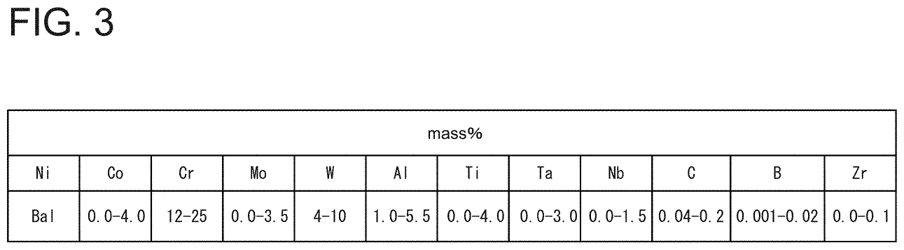

FIG. 3 is a table showing the composition of the additive manufacturing alloy powder according to some embodiments. With reference to FIG. 3, precipitates in nickel-based alloys and components of the additive manufacturing alloy powder according to some embodiments will now be described.

(γ′ Phase)

The γ′ phase is a precipitate mainly consisting of Ni, Ti, Al, and Ta. The γ′ phase contributes to the strengthening of the material by finely dispersed precipitation in the crystal grains during heat treatment.

(Mc Carbide)

“M” of MC carbide mainly represents Ti, Ta, and Nb. MC carbides are precipitated after additive manufacturing.

As described above, in conventional casting materials, coarse MC carbides are sparsely precipitated, but in additively manufactured materials, fine MC carbides are dispersed and precipitated in the crystal grains due to rapid solidification.

As described above, when fine MC carbides are dispersed and precipitated in the crystal grains, the grain boundaries cannot be moved by subsequent heat treatment, and the strongly anisotropic crystal form cannot be overcome. Therefore, it is necessary to reduce the precipitation of MC carbides as much as possible.

However, a certain amount of Ti, Ta, and Nb should be added because they are constituent elements of the γ′ phase, which is the strengthening phase of the matrix.

(M₂₃C₆ Carbide)

“M” of M₂₃C₆ carbide mainly represents Cr, Ni, and W.

M₂₃C₆ carbides, which are precipitated at grain boundaries after aging heat treatment, increase grain boundary strength and suppress grain boundary fracture during creep deformation, thus exhibiting strong notch strengthening properties against stress concentration.

In the following, when the content of each element is expressed in percentage, it is expressed in mass % unless otherwise specified.

(Co: 0.0% or More and Less than 4.0%)

Co has the effect of increasing the limit of solid solution of Ti, Al, etc., in the matrix at high temperature (solid solubility limit), and thus the addition of a certain amount of Co is effective. On the other hand, as the addition amount of Co increases, the precipitation amount of MC carbides tends to increase. In particular, this tendency is strong when the Co is more than 4%. Thus, in some embodiments, the Co content is 0.0% or more and less than 4%. Within the above range, the Co content is preferably less than 1.0%.

(Cr: 12% or More and 25% or Less)

Cr is an effective element for improving oxidation resistance at high temperature, but the addition of less than 12% Cr cannot sufficiently improve oxidation resistance at high temperature. As the Cr content increases, the precipitation amount of MC carbides tends to decrease, so the addition of 12% or more Cr is effective. On the other hand, when the Cr content is more than 25%, a harmful phase is precipitated, which causes a reduction in strength and ductility and thus is undesirable. For this reason, the Cr content is within the range of 12% or more and 25% or less.

(W: 4% or More and 10% or Less)

W is dissolved in the γ phase, which is the matrix, and improves strength through solid solution strengthening. In addition, although W is a constituent element of M₂₃C₆ carbides, the W diffusion is slow, which is effective in suppressing the coarsening of M₂₃C₆ carbides. In order to achieve these effects, 4% or more W needs to be added. However, when the W content is more than 10%, a harmful phase is precipitated, which causes a reduction in strength and ductility. For this reason, the W content is within the range of 4% or more and 10% or less.

(Mo: 0.0% or More and 3.5% or Less)

Mo is dissolved in the γ phase, which is the matrix, and improves strength through solid solution strengthening, like W. However, when the Mo content is more than 3.5%, a harmful phase is precipitated, which causes a reduction in strength and ductility. For this reason, when Mo is added, the addition amount of Mo is within the range of 0.0% or more and 3.5% or less.

(Al: 1.0% or More and 5.5% or Less)

Al is an element that forms the γ′ phase, which increases the high-temperature strength of the alloy, especially the high-temperature creep strength, through precipitation strengthening by γ′ phase precipitate particles, and also improves oxidation resistance and corrosion resistance at high temperature. When Al is less than 1.0%, the precipitation amount of the γ′ phase decreases, and precipitation strengthening by precipitate particles cannot be sufficiently achieved. On the other hand, when Al is more than 5.5%, weldability is reduced, and cracking may occur frequently during additive manufacturing. For this reason, the Al content is within the range of 1.0% or more and 5.5% or less.

(Ti: 0.0% or More and 4.0% or Less)

Ti is an element that forms the γ′ phase, which increases the high-temperature strength of the alloy, especially the high-temperature creep strength, through precipitation strengthening by γ′ phase precipitate particles, and also improves oxidation resistance and corrosion resistance at high temperature. When Ti is more than 4.0%, weldability is reduced, and cracking may occur frequently during additive manufacturing. In addition, Ti increases the precipitation amount of MC carbides and inhibits grain coarsening during heat treatment. Thus, it is necessary to control the Ti amount to 4.0% or less. For this reason, the addition amount of Ti is within the range of 0.0% or more and 4.0% or less. Within the above range, the Ti content is preferably 0.0% or more and 2.0% or less.

(Ta 0.0% or More and 3.0% or Less)

Ta is also an element that forms the γ′ phase, which increases the high-temperature strength of the alloy, especially the high-temperature creep strength, through precipitation strengthening by γ′ phase precipitate particles. Ta produces MC carbides that are stable at high temperature in the crystal grains, and the addition of more than 3.0% Ta increases the precipitation amount of MC carbides and inhibits grain coarsening during heat treatment. For this reason, the addition amount of Ta is within the range of 0.0% or more and 3.0% or less.

(Nb: 0.0% or More and Less than 1.5%)

Nb is also an element that forms the γ′ phase, which increases the high-temperature strength of the alloy, especially the high-temperature creep strength, through precipitation strengthening by γ′ phase precipitate particles. Nb produces MC carbides that are stable at high temperature in the crystal grains, and the addition of more than 1.5% Nb increases the precipitation amount of MC carbides and inhibits grain coarsening during heat treatment. For this reason, the addition amount of Nb is within the range of 0.0% or more and less than 1.5%. Within the above range, the Nb content is preferably less than 1.0%.

(C: 0.04% or More and 0.2% or Less)

C produces carbides represented by M₂₃C₆ carbides and MC carbides, and can cause grain boundary strengthening especially through precipitation of M₂₃C₆ carbides at the grain boundaries by appropriate heat treatment. When the C content is less than 0.04%, the amount of carbides is too small, and no strengthening effect can be expected. On the other hand, when C is more than 0.2%, the amount of MC carbides precipitated in the crystal grains increases, so that grain coarsening during heat treatment is inhibited due to the increased MC carbide precipitates. For this reason, the C content is within the range of 0.04% or more and 0.2% or less.

(B: 0.001% or More and 0.02% or Less)

B present at the grain boundaries has the effect of strengthening the grain boundaries and improving high-temperature creep strength and notch weakening, for which 0.001% or more B needs to be added. However, when B is more than 0.02%, borides may be produced, reducing ductility. For this reason, the B content is within the range of 0.001% or more and 0.02% or less.

(Zr: 0.0% or More and Less than 0.1%)

Zr present at the grain boundaries has the effect of strengthening the grain boundaries and improving high-temperature creep strength and notch weakening. When Zr is more than 0.1%, there is a risk of lowering the local melting point at the grain boundaries and causing a decrease in strength. For this reason, the addition amount of Zr is within the range of 0.0% or more and less than 0.1%.

(Re: 0.0% or More and 10% or Less)

Re is dissolved in the γ phase, which is the matrix, and improves strength through solid solution strengthening. However, since it is expensive rare metal, the addition of Re increases the material cost significantly, and even if not added, sufficient material properties can be secured by the effects of other elements, so Re need not to be added actively. Re is allowed to be included as incidental impurities.

Therefore, Re may be at or below the detection limit although it can be included. For example, the Re content may be 0.0% or more and 10% or less. Re content at or below the detection limit means that there is no clear Re peak in the X-ray photoelectron spectra in a sample, for example.

With the additive manufacturing alloy powder and the additively manufactured material made of the powder according to some embodiments, since rhenium, which is a kind of expensive rare metal, does not need to be added, it is possible to reduce the cost of the additive manufacturing alloy powder and the additively manufactured material.

(Ru: 0.0% or More and 10% or Less)

Since Ru suppresses the formation of harmful precipitates, the addition of Ru allows the addition of more Re. However, since Ru is expensive rare metal like Re, the addition of Ru increases the material cost significantly, and even if not added, sufficient material properties can be secured by the effects of other elements, so Ru need not to be added actively. Ru is allowed to be included as incidental impurities.

Therefore, Ru may be at or below the detection limit although it can be included. For example, the Ru content may be 0.0% or more and 10% or less. Ru content at or below the detection limit means that there is no clear Ru peak in the X-ray photoelectron spectra in a sample, for example.

With the additive manufacturing alloy powder and the additively manufactured material made of the powder according to some embodiments, since ruthenium, which is a kind of expensive rare metal, does not need to be added, it is possible to reduce the cost of the additive manufacturing alloy powder and the additively manufactured material.

The remainder of the elements includes Ni and incidental impurities. This type of Ni-based alloy may contain Fe, Si, Mn, Cu, P, S, N, etc., as incidental impurities, but it is desirable that Fe, Si, Mn, and Cu are 0.5% or less, and P, S, and N are 0.01% or less, respectively.

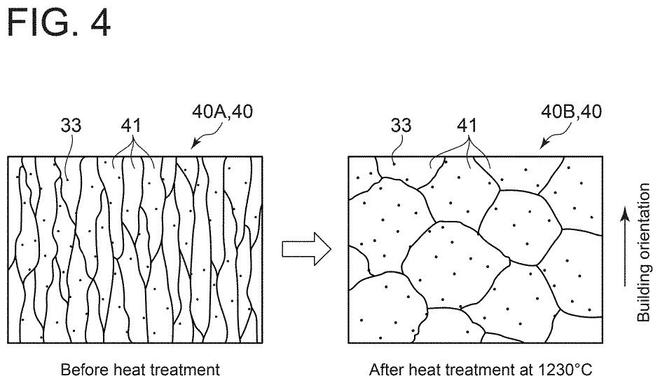

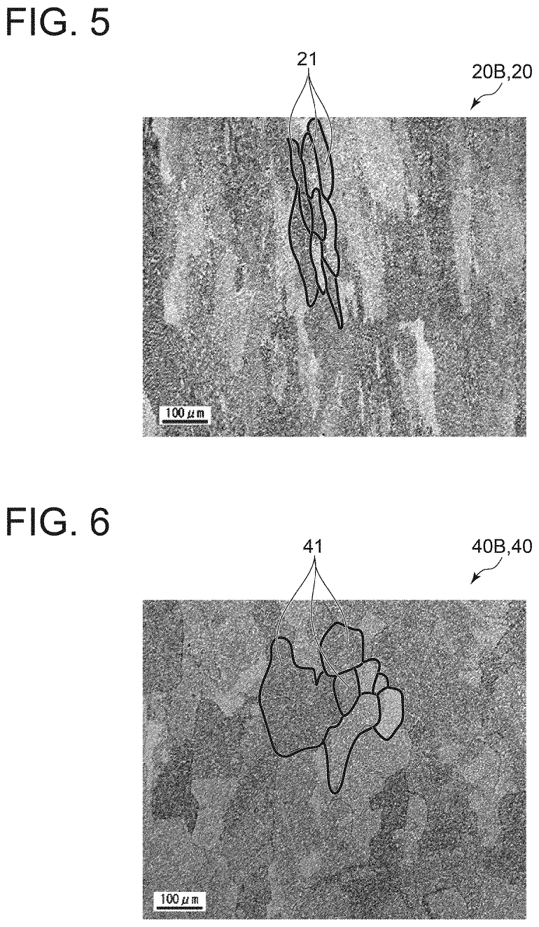

FIG. 4 is a schematic diagram of an example of the microstructure of the additively manufactured material 40 obtained by additive manufacturing using the additive manufacturing alloy powder according to the above-described embodiments before and after heat treatment. FIG. 5 is a diagram of the microstructure of the additively manufactured material 20 made of the conventional additive manufacturing alloy powder after heat treatment. FIG. 6 is a diagram of the microstructure of the additively manufactured material 40 made of the additive manufacturing alloy powder according to some embodiments after heat treatment. The heat treatment temperature for each additively manufactured material 20, 40 shown in FIGS. 5 and 6 is 1230° C. Further, in FIGS. 5 and 6, the outlines of some grains are highlighted for the sake of clarity of explanation.

As shown in FIG. 4, the additively manufactured material 40A before heat treatment has strongly anisotropic crystal grains 41 whose length in the building orientation is longer than that in the direction perpendicular to the building orientation, for example, with an aspect ratio of more than 3. By heat-treating the additively manufactured material 40A at 1230° C. for example as described below, the additively manufactured material 40B after heat treatment shown in FIG. 4 is obtained. The additively manufactured material 40B after heat treatment has coarsened crystal grains 41, and the length anisotropy is suppressed to approximate an isotropic form. In the additively manufactured material 40B after heat treatment, the aspect ratio of the crystal grain is, for example, 1 or more and less than 3.

Herein, the aspect ratio is a dimensionless number obtained by dividing the length in the longitudinal direction of each grain by the length in the perpendicular direction to the longitudinal direction. In other words, the aspect ratio of the crystal grain is the value obtained by dividing the major axis length of the grain by the minor axis length. For example, the larger the aspect ratio of the crystal grain than 1, the more elongated the crystal grain is.

For example, as shown in FIG. 5, in the additively manufactured material 20B after heat treatment made of the conventional additive manufacturing alloy powder, the length anisotropy of the crystal grains 21 is not much suppressed, compared to the additively manufactured material 20A before heat treatment, which is not shown in FIG. 5. For example, the additively manufactured material 20B after heat treatment made of the conventional additive manufacturing alloy powder shown in FIG. 5 has an aspect ratio of 5.8.

In contrast, for example, as shown in FIG. 6, in the additively manufactured material 40B after heat treatment made of the additive manufacturing alloy powder according to some embodiments, the crystal grains 41 are coarsened, and the length anisotropy is suppressed to approximate an isotropic form, compared to the additively manufactured material 40A before heat treatment, which is not shown in FIG. 6. For example, the additively manufactured material 40B after heat treatment made of the additive manufacturing alloy powder according to some embodiments shown in FIG. 6 has an aspect ratio of 1.8.

Thus, in the additively manufactured material 40 made of the additive manufacturing alloy powder according to some embodiments, by heat treatment described later, the aspect ratio of the crystal grain is set to be 1 or more and less than 3. In other words, in the additively manufactured material 40 made of the additive manufacturing alloy powder according to some embodiments, since the precipitation of MC carbides is effectively suppressed, the movement of grain boundaries by heat treatment is less likely to be inhibited by MC carbides. This makes it easier to coarsen the crystal grains such that the aspect ratio of the crystal grain is 1 or more and less than 3 even at a relatively low heat treatment temperature.

As a result, since the aspect ratio of the crystal grain is 1 or more and less than 3, it is possible to reduce the variation in physical properties including strength of the additively manufactured material depending on the orientation.

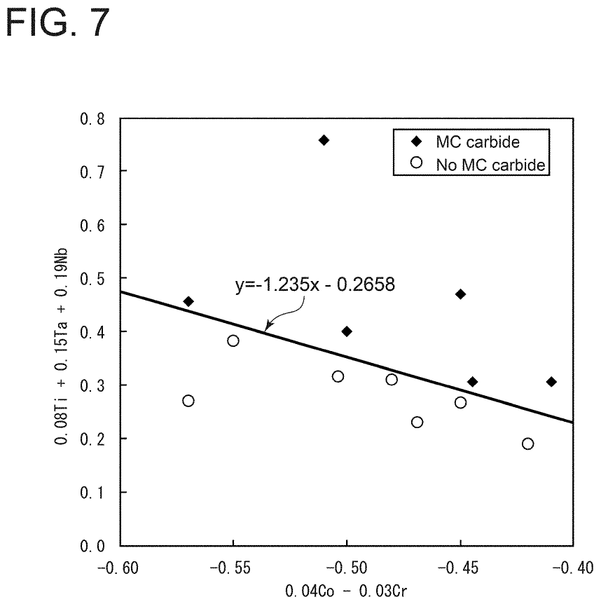

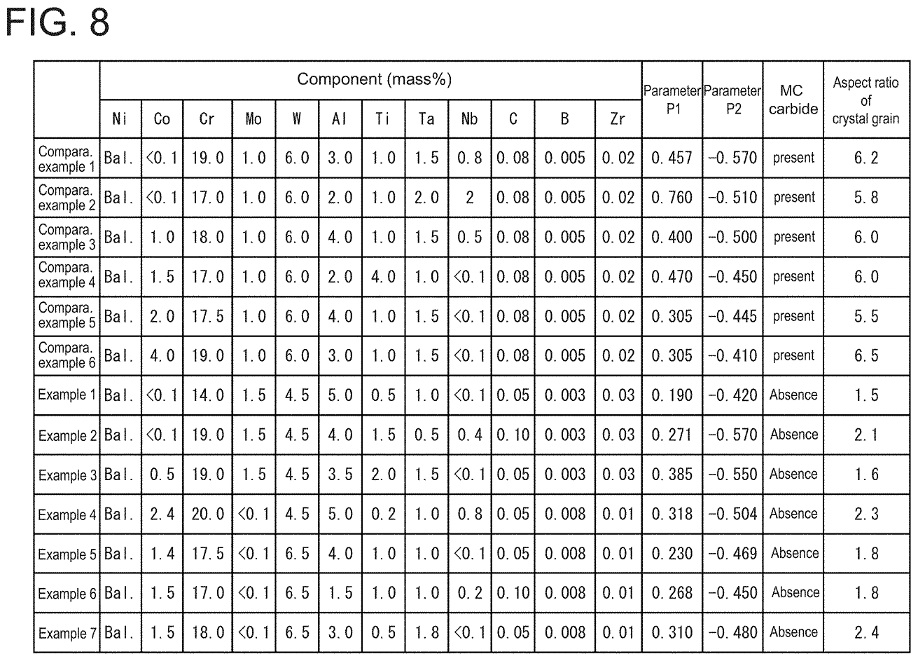

FIG. 7 is a graph showing a relationship between the first parameter P1 and the second parameter P2, which are described later, for each element contained in the additive manufacturing alloy powder according to some embodiments. FIG. 8 is a table showing the composition and component in each plot in FIG. 7.

The composition ratios of elements in the additive manufacturing alloy powder according to some embodiments will now be described mainly with reference to FIG. 7.

The effects of each element on the precipitation of MC carbides were examined by the inventors by classifying the elements into those that directly constitute MC carbides and those that are present in solid solution with the matrix and affect the precipitation of MC carbides, and the following was found: The first parameter P1 related to titanium, tantalum, and niobium, which are constituent elements of MC carbides, is represented by the following expression (A).

P1=0.08×Ti+0.15×Ta+0.19×Nb (A)

In the expression (A), “Ti”, “Ta”, and “Nb” are parameters related to the contents of titanium, tantalum, and niobium in the additive manufacturing alloy powder, respectively, and are expressed in terms of mass %.

Further, the second parameter P2 related to cobalt and chromium, which is dissolved in the matrix and affect the precipitation of MC carbides, is expressed by the following expression (B).

P2=0.04×Co−0.03×Cr (B)

In the expression (B), “Co” and “Cr” are parameters related to the contents of cobalt and chromium in the additive manufacturing alloy powder, respectively, and are expressed in terms of mass %.

When the first parameter P1 and the second parameter P2 satisfy the relation represented by the following expression (C), the precipitation of MC carbides can be effectively suppressed.

P1<−1.235×P2−0.2658 (C)

FIG. 7 is a graph with the first parameter P1 on the vertical axis and the second parameter P2 on the horizontal axis. The line shown in FIG. 7 is the line represented by the following expression (D), i.e., the expression where the inequality sign in the expression (C) is replaced by the equal sign.

y=−1.235×x−0.2658 (D)

Even when the expression (C) is “P1<−1.24×P2−0.27”, the precipitation of MC carbides can be effectively suppressed. In this case, the expression (D) is “y=−1.24×x−0.27”.

In FIG. 7, the white circle plot represents the additively manufactured material in which few MC carbides are precipitated, while the black diamond plot represents the additively manufactured material in which many MC carbides are precipitated. In FIG. 7, the white circle plots pertaining to the additively manufactured material with few MC carbide precipitates correspond to Examples 1 to 7 in FIG. 8, all of which satisfy the relation represented by the expression (C). Meanwhile, in FIG. 7, the black diamond plots pertaining to the additively manufactured material with many MC carbide precipitates correspond to Comparative examples 1 to 6 in FIG. 8, none of which satisfy the relation represented by the expression (C).

In other words, as is apparent from FIGS. 7 and 8, when the additive manufacturing alloy powder according to some embodiments satisfies the relation represented by the expression (C), it is possible to effectively suppress the precipitation of MC carbides in the additively manufactured material 40B.

(Heat Treatment)

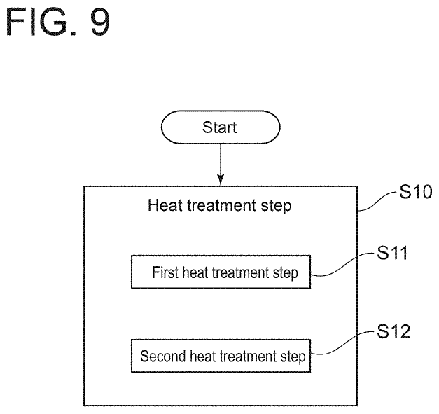

FIG. 9 is a flowchart of heat treatment of the additively manufactured material 40A obtained by additive manufacturing using the additive manufacturing alloy powder according to some embodiments.

The heat treatment according to some embodiments includes a heat treatment step S10 of heat-treating the additively manufactured material 40A obtained by additive manufacturing using the additive manufacturing alloy powder according to some embodiments at a temperature lower than 1250° C.

As described above, by using the additive manufacturing alloy powder according to some embodiments, it is possible to coarsen the crystal grains and bring them closer to an isotropic form even when the heat treatment temperature of the additively manufactured material 40A is lower than 1250° C.

Therefore, according to some embodiments, it is possible to reduce the anisotropy of crystals while suppressing the deformation of the additively manufactured material 40 composed of nickel-based alloy. Further, according to some embodiments, since the heat treatment temperature is lower than 1250° C., it is possible to reduce the anisotropy of crystals while more effectively suppressing the deformation of the additively manufactured material 40.

The heat treatment step S10 according to some embodiments includes a first heat treatment step S11 and a second heat treatment step S12.

The first heat treatment step S11 according to some embodiments is to remove the stress of the additively manufactured material 40A obtained by additive manufacturing using the additive manufacturing alloy powder according to some embodiments in order to prevent the additively manufactured material 40A from deforming due to residual stress in manufacturing. In the first heat treatment step S11 according to some embodiments, the additively manufactured material 40A is heat-treated at a temperature of 1200° C., for example.

The second heat treatment step S12 according to some embodiments involves heat treatment to homogenize the additively manufactured material 40A and coarsen the crystal grains after the first heat treatment step S11. In the second heat treatment step S12 according to some embodiments, the additively manufactured material 40A is heat-treated at a temperature lower than 1250° C. In the second heat treatment step S12 according to some embodiments, the additively manufactured material 40A is heat-treated at a temperature of 1230° C.

In particular, according to the heat treatment of some embodiments, the heat treatment step S10 (second heat treatment step S12) involves heat treatment of the additively manufactured material 40A at a temperature equal to or lower than 1230° C., as described with reference to FIGS. 4 and 6.

With this treatment, it is possible to reduce the anisotropy of crystals while more effectively suppressing the deformation of the additively manufactured material 40.

The present invention is not limited to the embodiments described above, but includes modifications to the embodiments described above, and embodiments composed of combinations of those embodiments.

### REFERENCE SIGNS LIST

10 Casting
11 Crystal grain
20 Additively manufactured material (Additively manufactured material made of conventional additive manufacturing alloy powder)
21 Crystal grain
31, 33 MC carbides
40 Additively manufactured material (Additively manufactured material made of additive manufacturing alloy powder according to some embodiments)
40A Additively manufactured material (Additively manufactured material before heat treatment)
40B Additively manufactured material (Additively manufactured material after heat treatment)
41 Crystal grain

1. An alloy powder for additive manufacturing composed of a nickel-based alloy, comprising:
0.0 mass % or more and less than 4.0 mass % of cobalt;
12 mass % or more and 25 mass % or less of chromium;
1.0 mass % or more and 5.5 mass % or less of aluminum;
0.0 mass % or more and 4.0 mass % or less of titanium;
0.0 mass % or more and 3.0 mass % or less of tantalum; and
less than 1.5 mass % of niobium.

2. The alloy powder for additive manufacturing according to claim 1, comprising
0.0 mass % or more and less than 1.0 mass % of cobalt.

3. The alloy powder for additive manufacturing according to claim 1, comprising
0.0 mass % or more and 2.0 mass % or less of titanium.

4. The alloy powder for additive manufacturing according to claim 1, comprising
0.0 mass % or more and less than 1.0 mass % of niobium.

5. The alloy powder for additive manufacturing according to claim 1,
wherein a rhenium content is at or below a detection limit.

6. The alloy powder for additive manufacturing according to claim 1,
wherein a ruthenium content is at or below a detection limit.

7. The alloy powder for additive manufacturing according to claim 1,
wherein when a first parameter P1 is represented by the following expression (A):
P1=0.08×Ti+0.15×Ta+0.19×Nb (A), and
a second parameter P2 is represented by the following expression (B):
P2=0.04×Co−0.03×Cr (B),
where Ti (mass %) is a parameter related to a titanium content,
Ta (mass %) is a parameter related to a tantalum content,
Nb (mass %) is a parameter related to a niobium content,
Co (mass %) is a parameter related to a cobalt content, and
Cr (mass %) is a parameter related to a chromium content,
the first parameter P1 and the second parameter P2 satisfy a relation represented by the following expression (C):
P1<−1.24×P2−0.27 (C).

8. An additive manufacturing method, comprising:
a first heat treatment step to remove a stress of an additively manufactured material formed by additive manufacturing using the alloy powder according to claim 1; and
a second heat treatment step of performing heat treatment at a temperature lower than 1250° C. to coarsen a crystal grain of the additively manufactured material after the first heat treatment step.

9. The additive manufacturing method according to claim 8,
wherein the second heat treatment step includes performing heat treatment of the additively manufactured material at a temperature equal to or lower than 1230° C.

10. An additively manufactured material composed of a nickel-based alloy, comprising:
0.0 mass % or more and less than 4.0 mass % of cobalt;
12 mass % or more and 25 mass % or less of chromium;
1.0 mass % or more and 5.5 mass % or less of aluminum;
0.0 mass % or more and 4.0 mass % or less of titanium;
0.0 mass % or more and 3.0 mass % or less of tantalum; and
less than 1.5 mass % of niobium.

11. The additively manufactured material according to claim 10, comprising
0.0 mass % or more and less than 1.0 mass % of cobalt.

12. The additively manufactured material according to claim 10, comprising
0.0 mass % or more and 2.0 mass % or less of titanium.

13. The additively manufactured material according to claim 10, comprising
0.0 mass % or more and less than 1.0 mass % of niobium.

14. The additively manufactured material according to claim 10,
wherein a rhenium content is at or below a detection limit.

15. The additively manufactured material according to claim 10,
wherein a ruthenium content is at or below a detection limit.

16. The additively manufactured material according to claim 10,
wherein when a first parameter P1 is represented by the following expression (A):
P1=0.08×Ti+0.15×Ta+0.19×Nb (A), and
a second parameter P2 is represented by the following expression (B):
P2=0.04×Co−0.03×Cr (B),
where Ti (mass %) is a parameter related to a titanium content,
Ta (mass %) is a parameter related to a tantalum content,
Nb (mass %) is a parameter related to a niobium content,
Co (mass %) is a parameter related to a cobalt content, and
Cr (mass %) is a parameter related to a chromium content,
the first parameter P1 and the second parameter P2 satisfy a relation represented by the following expression (C):
P1<−1.24×P2−0.27 (C).

17. The additively manufactured material according to claim 10,
wherein an aspect ratio of a crystal grain of the additively manufactured material is 1 or more and less than 3.
